(19) United States
(12) Patent Application Publication
(10) Pub. No.: US 2009/0254715 A1
(43) Pub. Date: Oct. 8, 2009

(54) VARIABLE PARTITIONED BLOCKS IN SHARED MEMORY

(75) Inventor: Jong-Sik Jeong, Seoul (KR)

Correspondence Address: BIRCH STEWART KOLASCH & BIRCH, PO BOX 747, FALLS CHURCH, VA, 22040-0747, US

(73) Assignee: MTEKVISION CO., LTD., Seoul (KR)

(21) Appl. No.: 11/909,085

(22) PCT Filed: Sep. 15, 2005
(86) PCT No.: PCT/KR05/03062

§ 371 Date: Sep. 19, 2007

(30) Foreign Application Priority Data
Mar. 23, 2005 (KR) 10-2005-0024210

(51) Int. Cl. G06F 12/02; G06F 12/00

(52) U.S. Cl. 711/153; 711/147; 711/E12.001; 711/E12.002

(57) ABSTRACT

A method and device for varying the size of partitioned areas of a shared memory is disclosed. The present invention resets the size of partitioned areas by expanding the size of a shared area when data that is larger than the writable area of the shared area is to be written, after the storage area of a memory unit is partitioned to a plurality of partitioned areas by a main control unit. The memory unit is coupled with a main control unit and a supplementary control unit through independent ports. With the present invention, the data communication time between control units for processing data can be minimized, and the operation speed of each control unit can be optimized.

### TECHNICAL FIELD

The present invention is directed to a portable terminal, particularly to a portable terminal having a plurality of processors.

### BACKGROUND ART

A portable terminal refers to a compact electronic device that is designed to be easily carried by a user in order to perform functions such as game or mobile communication. A portable terminal can be a mobile communication terminal, a personal digital assistant (PDA), or a portable multimedia player (PMP).

A mobile communication terminal generally refers to a device designed to allow a mobile user to telecommunicate with a remotely-located receiver. Through technological developments, however, the latest mobile communication terminals are equipped with extra features, such as camera and multimedia data playback, to the essential functions of mobile communication, short message communication, and address book.

FIG. 1 shows a block diagram of a conventional mobile communication terminal having a camera function.

Referring to FIG. 1, the mobile communication terminal 100 having a camera function comprises a high frequency processing unit 110, an A/D conversion unit 115, a D/A conversion unit 120, a control unit 125, a power supply 130, a key input 135, a main memory 140, a display 145, a camera 150, an image processing unit 155, and a support memory 160.

The high frequency processing unit 110 processes a high frequency signal, which is transmitted or received through an antenna.

The A/D conversion unit 115 converts an analog signal, outputted from the high frequency processing unit 110, to a digital signal and sends to the control unit 125.

The D/A conversion unit 120 converts a digital signal, outputted from the control unit 125, to an analog signal and sends to the high frequency processing unit 110.

The control unit 125 controls the general operation of the mobile communication terminal 100. The control unit 125 can comprise a central processing unit (CPU) or a micro-controller.

The power supply 130 supplies electric power required for operating the mobile communication terminal 100. The power supply 130 can be coupled to, for example, an external power source or a battery.

The key input 135 generates key data for, for example, setting various functions or dialing of the mobile communication terminal 100 and sends to the control unit 125.

The main memory 140 stores an operating system and a variety of data of the mobile communication terminal 100. The main memory 140 can be, for example, a flash memory or an EEPROM (Electrically Erasable Programmable Read Only Memory).

The display 145 displays the operation status of the mobile communication terminal 100 and an external image photographed by the camera 150.

The camera 150 photographs an external image (a photographic subject), and the image processing unit 155 processes the external image photographed by the camera 150. The image processing unit 155 can perform functions such as color interpolation, gamma correction, image quality correction, and JPEG encoding. The support memory 160 stores the external image processed by the image processing unit 155.

As described above, the mobile communication terminal 100 having a camera function is equipped with a plurality of processors (that is, a main control unit and one or more supplementary control unit for performing additional functions). In other words, as shown in FIG. 1, the control unit 125 for controlling general functions of the mobile communication terminal 100 and the image processing unit 155 for controlling the camera function are included. Moreover, each processor is structured to be coupled with an independent memory.

The supplementary control unit can take different forms depending on the kinds of additional functions, with which the portable terminal is equipped. For example, the supplementary control unit for controlling the camera function can process functions such as JPEG encoding and JPEG decoding; the supplementary control unit for controlling the movie file playback function can process functions such as video file (e.g., MPEG4, DIVX, H.264) encoding and decoding; and the supplementary control unit for controlling the music file playback function can process functions such as audio file encoding and decoding. Of course, there can be a supplementary control unit that can process various aforementioned functions altogether. Each of these control units has an individual memory for storing the data processed by the control unit.

FIG. 2 illustrates an example of a coupling structure among a main control unit, a supplementary control unit, and their corresponding memories in accordance with the conventional art.

Referring to FIG. 2, the main control unit 210 and the supplementary control unit 220 communicate information through bus #1; the main control unit 210 is coupled with the main memory 230 through bus #2; and the supplementary control unit 220 is coupled to the supplementary memory 240 through bus #3. A bus refers to a common-purpose electric pathway that is used to transmit information between the control unit, the main memory, and the input/output in a device such as a computer. A bus comprises a line for data, designating the address of each device or the location of the memory, and a line for distinguishing a variety of data transmission operation to be processed.

As illustrated in FIG. 2, each control unit 210, 220 is independently coupled with each memory 230, 240. Therefore, the main control unit 210 reads the data stored in the main memory 230 and transmits the data to the supplementary control unit 220 through a host interface or requests the supplementary control unit 220 to read the data stored in the supplementary memory 240.

In this case, the larger the amount of data, communicated between the main control unit 210 and the supplementary control unit 220, is, the more time each control unit 210, 220 spends on the operation (i.e. memory access, host interface operation) requested by the other control unit rather than the operation requested by its own processor.

This problem causes a bottleneck problem in data communication between the main control unit 210 and the supplementary control unit 220 as the amount of data to be processed and the functions performed by a portable terminal increase.

As a result, the problems described above weaken the overall performance of a multi-function portable terminal.

### DISCLOSURE

### Technical Problem

Therefore, in order to solve the problems described above, it is an object of the present invention to provide a portable terminal having a shared memory and a method for varying the size of partitioned areas of the shared memory that can minimize the length of data transmission time and optimize the operation speed of each control unit, by assigning a dedicated area to each of the plurality of control units coupled to the shared memory.

It is another object of the present invention to provide a portable terminal having a shared memory and a method for varying the size of partitioned areas of the shared memory that can optimally partition the memory by having the main control unit assign the storage area of the memory as a shared area and a dedicated area for each supplementary control unit.

It is yet another object of the present invention to provide a portable terminal having a shared memory and method for varying the size of partitioned areas of the shared memory that can ease the sharing of needed data by having a plurality of control units share a single memory.

It is still another object of the present invention to provide a portable terminal having a shared memory and a method for varying the size of partitioned areas of the shared memory that can process data highly efficiently by eliminating the loss of time needed to communicate the data, stored in a specific memory, between the control units.

### Technical Solution

In order to achieve the above objects, an aspect of the present invention features a portable terminal having a shared memory that can vary the size of partitioned areas.

According to a preferred embodiment of the present invention, the portable terminal comprises a memory unit; a supplementary control unit coupled to the memory unit through bus #1, the supplementary control unit processing and storing raw data in accordance with a process order, the raw data being stored in the memory unit, the memory unit being accessed through bus #1; and a main control unit coupled to the memory unit through bus #2 and coupled to the supplementary control unit through bus #3, the main control unit transmitting the process order to the supplementary control unit through bus #3. A storage area of the memory unit is partitioned into a first dedicated area accessible by the supplementary control unit only, a second dedicated area accessible by the main control unit only, and a shared area and a variable area accessible by the supplementary control unit and the main control unit, and the variable area is variably changed to be included in at least one of the first dedicated area, the second dedicated area, and the shared area to correspond to area partition information generated by one of the main control unit and the supplementary control unit.

The memory unit has a separate interface structure for communicating information with the supplementary control unit through bus #1 and for communicating information with the main control unit through bus #2.

In the above portable terminal, a first control unit (either the main control unit or the supplementary control unit) can generate the area partition information and transmit to a second control unit (the other of either said main control unit or said supplementary control unit) through bus #3.

Moreover, the first control unit, accessed to the shared area, can generate area re-partition information if the size of the data to be written is larger than the size of writable capacity of the shared area, and the size of the shared area can be expanded by including partial or whole variable area, included in at least one of the first dedicated area and the second dedicated area, in the shared area in accordance with the area re-partition information.

The above bus #2 can have priority over the above bus #1.

The process order can comprise instruction information on the process type of the raw data and a storage location of the raw data. Moreover, the process order can further comprise location information for storing raw data processed to correspond to the instruction information.

In order to achieve the above objects, another aspect of the present invention features a method for varying the size of partitioned areas of a shared memory and a recorded medium recording a program for executing the method thereof.

According to a preferred embodiment of the present invention, the portable terminal comprises a memory unit, a main control unit coupled to the memory unit through bus #1, and a supplementary control unit coupled to the memory unit through bus #2 and coupled to the main control unit through bus #3. The method for varying the size of partitioned areas of a memory unit in a portable terminal comprises the steps of: the main control unit generating area partition information, for partitioning a storage area of the memory unit into a plurality of partitioned areas, and transmitting to the supplementary control unit, wherein the partitioned area comprises at least a first dedicated area accessible by the main control unit only, a second dedicated area accessible by the supplementary control unit only, and a shared area and a variable area accessible by the main control unit and the supplementary control unit, and the variable unit is included in at least one of the first dedicated area, the second dedicated area, and the shared area by the area partition information; the main control unit accessing the shared area in order to write data; the main control unit determining whether the size of the data to be written is smaller than the size of the writable area of the shared area; and if bigger, the main control generating area re-partition information and transmitting to the supplementary control unit. The size of the shared area is expanded by including partial or whole variable area, included in at least one of the first dedicated area and the second dedicated area, in the shared area in accordance with the area re-partition information.

The method for varying the size of partitioned areas of the memory unit can further comprise the steps of the supplementary control unit accessing the shared area in order to write data; the supplementary control unit determining whether the size of the data to be written is smaller than the size of the writable area of the shared area; and if bigger, the supplementary control unit transmitting an area re-partition request to the main control unit. Here, the main control unit can generate the area re-partition information in accordance with the area repartition request, and the size of the shared area can be expanded in accordance with the area repartition information.

Either the main control unit or the supplementary control unit, accessed to the shared area, can transmit access status information to the other of either of the main control unit or the supplementary control unit through the above bus #3.

According to another preferred embodiment of the present invention, the recorded medium tangibly embodies a program of instructions executable by a portable terminal to execute a method for varying the size of partitioned areas of a shared memory, and the program is readable by the portable terminal. The portable terminal comprises a memory unit, a main control unit, and a supplementary control unit. The main control unit is coupled with the memory unit through bus #1. The supplementary control unit is coupled with the memory unit through bus #2. The main control unit and the supplementary control unit are coupled with each other through bus #3. The recorded medium can execute the acts of the main control unit setting area partition information, for partitioning a storage area of the memory unit into a plurality of partitioned areas, and transmitting to the supplementary control unit, wherein the partitioned area comprises at least a first dedicated area accessible by the main control unit only, a second dedicated area accessible by the supplementary control unit only, and a shared area and a variable area accessible by the main control unit and the supplementary control unit, and the variable unit is included in at least one of the first dedicated area, the second dedicated area, and the shared area by the area partition information; the maid control unit accessing the shared area in order to write data; the main control unit determining whether the size of the data to be written is smaller than the size of the writable area of the shared area; and if bigger, the main control generating area re-partition information and transmitting to the supplementary control unit, wherein the size of the shared area is expanded by including partial or whole variable area, included in at least one of the first dedicated area and the second dedicated area, in the shared area in accordance with the area re-partition information.

The above program can further comprise the acts of the supplementary control unit determining whether the shared area is accessible in order to write data; if accessible, the supplementary control unit determining whether the size of the data to be written is smaller than the size of the writable area of the shared area; and if bigger, the supplementary control unit generating area re-partition information and transmitting to the main control unit.

The above program can further comprise the acts of the supplementary control unit determining whether the shared area is accessible in order to write data; if accessible, the supplementary control unit determining whether the size of the data to be written is smaller than the size of the writable area of the shared area; if bigger, the supplementary control unit transmitting an area re-partition request to the main control unit, and the main control unit generating the area repartition information and transmitting to the supplementary control unit.

The memory unit can transmit an inaccessible message to a second control unit if the second control unit attempts to access the shared area to write data while a first control unit is accessed to the shared area and is writing data. Here, the first control unit is either the main control unit or the supplementary control unit, and the second control unit is the other of either the main control unit or the supplementary control unit.

The main control unit can transmit access status information to the supplementary control unit in case the main control unit accesses the shared area to write data.

### DESCRIPTION OF DRAWINGS

FIG. 1 shows a block diagram of a conventional mobile communication terminal having a camera function;

FIG. 2 shows a block diagram of an example of a conventional coupling structure between a main control unit, a supplementary control unit, and each memory;

FIG. 3 shows a block diagram of a coupling structure between a main control unit, a supplementary control unit, and a memory unit, in accordance with a preferred embodiment of the present invention;

FIG. 4 shows a partition of the storage area of the memory unit in accordance with a preferred embodiment of the present invention;

FIG. 5 shows a flow chart of a method for varying the size of partitioned storage areas in accordance with a preferred embodiment of the present invention; and

FIG. 6 shows a block diagram of a coupling structure between the main control unit, the supplementary control unit, and the memory unit, in accordance with another preferred embodiment of the present invention.

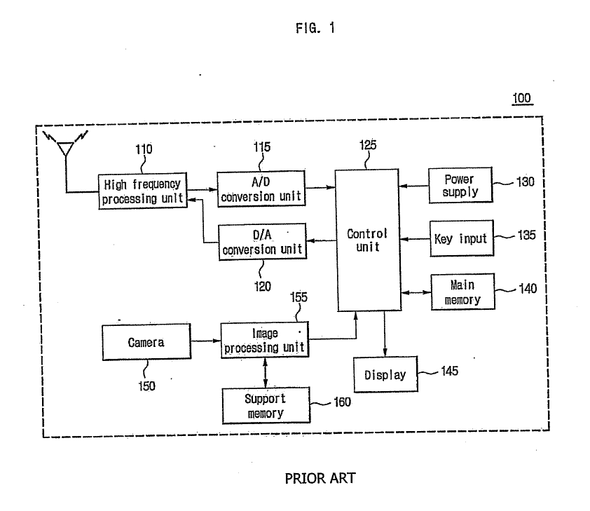

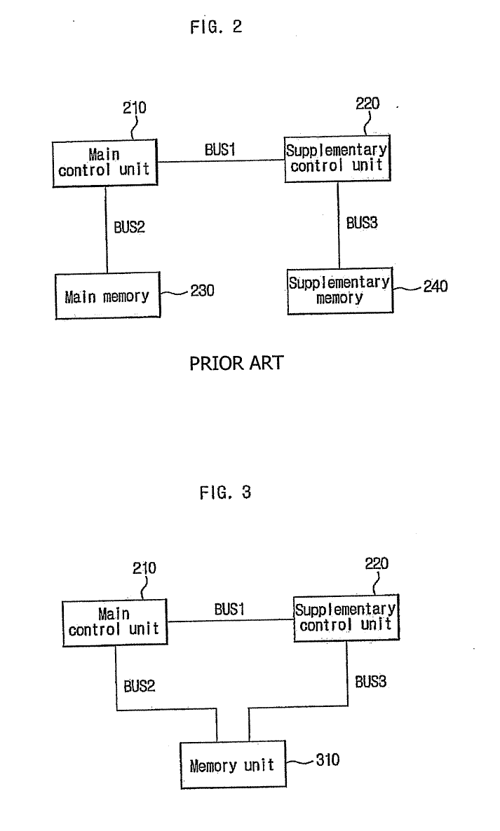

### DESCRIPTION OF KEY ELEMENTS

210: Main control unit
220: Supplementary control unit
310: Memory unit

### MODE FOR INVENTION

The present invention, operative advantages of the present invention, and objects achieved by embodying the present invention shall be apparent with reference to the accompanying drawings and the description therein.

Hereinafter, preferred embodiments of the present invention shall be described in detail with reference to the accompanying drawings. To aid overall understanding of the present invention, the same reference numbers shall be assigned to the same means, regardless of the figure number. Moreover, the numbers (e.g., bus #1, bus #2, first, second, etc.) are only used in the description to identify identical or similar elements.

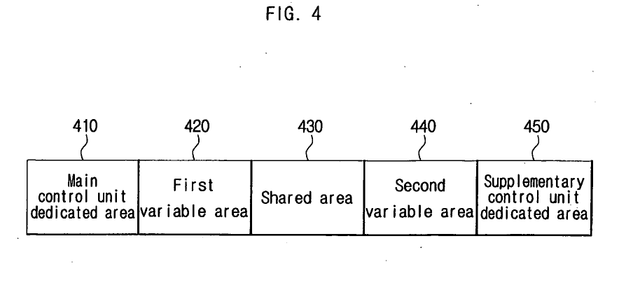

FIG. 3 is a block diagram showing a coupling structure between the main control unit, the supplementary control unit, and the memory unit, in accordance with a preferred embodiment of the present invention, and FIG. 4 shows a partition of the storage area of the memory unit in accordance with a preferred embodiment of the present invention;

Referring to FIG. 3, the main control unit 210 and the supplementary control unit 220 are coupled to transmit and receive data to and from each other through bus #1; the main control unit 210 and the memory unit 310 are coupled to transmit and receive data to and from each other through bus #2; and the supplementary control unit 220 and the memory unit 310 are coupled to transmit and receive data to and from each other through bus #3. A bus refers to a common-purpose electric pathway that is used to transmit and receive information between the control unit, the main memory, and the input/output in a device such as a computer. Here, the main control unit 210 can be a processor that controls the general operation of a portable terminal. Also, the supplementary control unit 220 can be a dedicated processor for processing the MPEG4, 3-D graphic, and camera functions.

The memory unit 310 is equipped with one or more ports for exclusively communicating data with the main control unit 210 and one or more ports for exclusively communicating data with the supplementary control unit 220.

For example, in a structure of the memory unit coupled to both the main control unit 210 and the supplementary control unit 220, as shown in FIG. 3, the two control units 210, 220 use one memory unit 310, thereby necessitating the memory unit 310 to have 2 access ports. In other words, the two access ports are configured to be identified as a first port (Addr_A, Data_A) and a second port (Addr_B, Data_B), having the first port and the second port connect to the main control unit 210 and the supplementary control unit 220, respectively.

As illustrated in FIG. 4, the storage area of a memory unit 310 can be divided into as few as 4 areas (i.e. a main control unit dedicated area 410, a shared area 430, a supplementary control unit dedicated area 450, and variable areas 420, 440) or as many as 5 areas (i.e. a main control unit dedicated area 410, a shared area 430, a supplementary control unit dedicated area 450, a first variable area 420, and a second variable area 440).

The first and second variable areas 420, 440 are configured to have any of the main control unit dedicated area 410, shared area 430, or supplementary control unit dedicated area 450 expand to in case it does not have sufficient space.

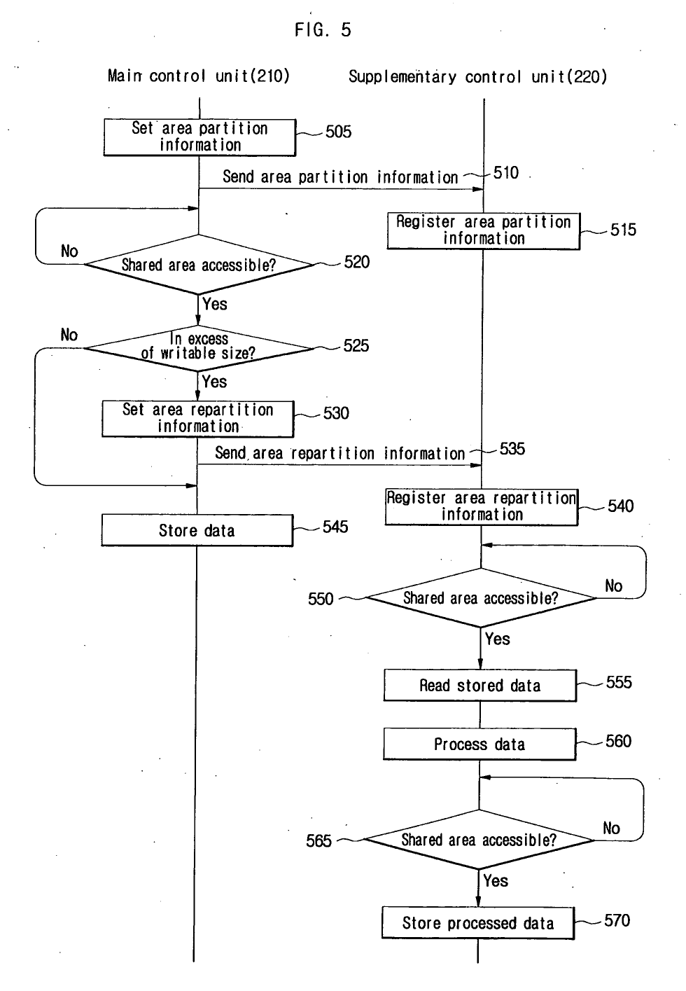

The above variable areas can be included in a specific area (e.g. at least one of the main control unit dedicated area 410, the shared area 430, and the supplementary control unit dedicated area 450), depending on the request (e.g. creating and sharing area partition information—refer to FIG. 5) of each control unit (i.e. the main control unit or the supplementary control unit).

Therefore, the minimum storage area that can be operated by sharing the area can be the shared area 430, while the maximum storage area can be the sum of the first variable area 420, the shared area 430, and the second variable area 440. Likewise, the size of the dedicated area, which each control unit can exclusive use, can depend on the addition of the variable area. Suppose the memory unit 310 has a storage size of 40 megabytes, and each of the main control unit dedicated area 410, shared area 430, supplementary control unit dedicated area 450, and variable areas 420, 440 has a storage area of 10 megabytes. Then, the 10 megabytes, assigned in the variable areas 420, 440 can be wholly or partially included in other storage areas, thereby increasing the size of the pertinent storage area. If, for example, the 10 megabytes of the variable area 420, 440 is included in the main control unit dedicated area 410, the main control unit dedicated area 410 functions as a 20-megabyte storage. Moreover, if the 10 megabytes of the variable area 420, 440 are divided into two 5 megabytes to be included in each of the main control unit dedicated area 410 and the shared area 430, the main control unit dedicated area 410 and the shared area 430 each functions as a 15-megabyte storage. The storage area, in which the variable area 420, 440 is to be included, can be changed by the control of the main control unit 210 and/or the variable control unit 220.

Each of the first and second variable areas 420, 440 can be included in at least one of the main control unit dedicated area 410, the shared area 430, or the supplementary control unit dedicated area 450 in the initial state. The method of varying the partitioned storage areas will be described later with reference to FIG. 5.

The main control unit 210 can process data by accessing the main control unit dedicated area 410 and/or the shared area 430 through the first port, and the supplementary control unit 220 can process data by accessing the supplementary control unit dedicated area 450 and/or the shared area 430 through the second port. However, the shared area 430 is restricted from being accessed by a plurality of control units 210, 220 simultaneously. The plurality of control units 210, 220 can be restricted from simultaneously accessing the shared area 430 by having the first accessed control unit notify the other control unit of the access (e.g. accessed address information) or having the memory unit 310 notify, if one of the control units access the shared area, the other control unit of the access. In other words, it is possible for the main control unit 210 and the supplementary control unit 220 to process data by simultaneously accessing the memory unit 310 through independent routes, and in this case a collision between the two control units can be prevented. In case, however, the portable terminal in accordance with the present invention is a mobile phone, the main function of which is a telephonic function, the access priority over the shared area 430 is given to the main control unit 210 when a telephonic communication is in progress by having received a call. For example, when a telephonic communication sorts while the supplementary control unit 220 is accessed to the shared area 430, the main control unit 210 can request the access to the shared area 430 by the supplementary control unit 220 to be released, and the supplementary control unit 220 can release the access to the shared area 430 in accordance with the request by the main control unit 210, thereby enabling the main control unit 210 to access the shared area 430.

The address information on the partitioned storage areas of the memory unit 310 can be set and managed by the main control unit 210, and the address information set by the main control unit 210 is provided to and shared by the supplementary control unit 220. Of course, the address information can be set and managed by the supplementary control unit 220 also, and, when necessary, one of the two control units 210, 220 can have the authority to set the address information and provide the address information to the other of the two control units 210, 220, enabling the sharing of address information.

The information on the partitioned storage areas of the memory unit 310 can be recognized by each control unit during the booting of the portable terminal.

FIG. 5 is a flow chart showing a method for varying the size of partitioned storage areas in accordance with a preferred embodiment of the present invention.

In the process illustrated in FIG. 5, the main control unit 210 processes certain data and stores it in the shared area 430, and then the supplementary control unit 220 reprocesses the data stored in the shared area 430 and re-stores it in the shared area 430. Moreover, the flowchart shown in FIG. 5 assumes that the main control unit 210 has the authority to set the size of the shared area 430 of the memory unit 310.

Referring to FIG. 5, in step 505, the main control unit 210 sets (i.e. sets the area partition information) the range of the address of each storage area, which is partitioned to partition the storage area of the memory unit 310 to a plurality of storage areas. In other words, the main control unit 210 writes proper values in the register, which allows the storage area of the memory unit 310 to be partitioned and set.

The main control unit 210 sends the set area partition information to the supplementary control unit 220 in step 510, and the supplementary control unit 220 registers the received area partition information in step 515, thereby allowing the area partition information of the memory unit 310 to be shared between the main control unit 210 and the supplementary control unit 220.

In step 520, the main control unit 210 determines if the shared area 430 of the storage area of the memory unit 310 is accessible. If it is not accessible (for example, the supplementary control unit 220 is already accessed to the same area), the process waits in step 520 until it becomes accessible.

If it is accessible, however, step 525 is performed to determine if the size of the data to be written in the shared area 430 is in excess of the size writable in the shared area 430. When the main control unit 210 is accessed to the shared area 430, it is necessary to send the access status of the main control unit 210 to the supplementary control unit 220 such that the supplementary control unit 220 does not access the shared area 430 at the same time. The pertinent information can be notified to the supplementary control unit 220 by the main control unit or the memory unit 310. The pertinent information can be notified through the status register.

If the size of the data to be written is small, step 545 is performed to store the data to be written in the shared area 430. The data stored in the shared area 430 can be either the result processed by the main control unit 210 or the data, which was stored in the main control unit dedicated area 410 for processing by the supplementary control unit 220, to be transferred to the shared area 430. The main control unit 210 can send a process order (e.g. the storage address information of the pertinent data, the process type, such as decoding, of the pertinent data) to the supplementary control unit 220 such that the supplementary control unit 220 can process the stored data.

However, if the size of the data to be written is in excess of the size of the writable area, the main control unit 210 re-sets (i.e. sets area repartition information), in step 530, the address range of each partitioned storage area.

In step 535, the main control unit 210 sends the set area repartition information to the supplementary control unit 220. In step 540, the supplementary control unit 220 registers the received area repartition information, thereby allowing the area repartition information of the memory unit 310 to be shared between the main control unit 210 and the supplementary control unit 220.

In step 545, the main control unit 210 stores the data to be written in the expanded shared area 430. It is possible, of course, for the main control unit 210 to perform steps 535 and 540 after storing the pertinent data in the expanded shared area 430.

In step 550, the supplementary control unit 220 determines if the shared area 430 of the storage area of the memory unit 310 is accessible. If it is not accessible (for example, the main control unit 210 is still accessed to the same area), the process waits in step 550 until it becomes accessible.

If it is accessible, however, step 555 is performed to read the data to be written and processed in the shared area 430. As described earlier, when the supplementary control unit 220 is accessed to the shared area 430, it is necessary to send the access status of the supplementary control unit 220 to the main control unit 210 such that the main control unit 210 does not access the shared area 430 at the same time.

In step 560, the supplementary control unit 220 processes the read data in a predetermined method. As described earlier, the process type of the pertinent data can be instructed by the main control unit 210.

In step 565, the supplementary control unit 220 determines if the shared area 430 of the storage area of the memory unit 310 is accessible. If it is not accessible (for example, the main control unit 210 is accessed to the same area), the process waits in step 565 until it becomes accessible.

If it is accessible, however, step 570 is performed to have the supplementary control unit 220 write the data processed through step 560 in the shared area 430. If the size of the data to be written is in excess of the size of the writable area of the shared area 430, the supplementary control unit 220 can send an area repartition request to the main control unit 210, and can write the pertinent data after the shared area 430 is expanded.

By referencing FIG. 5, the method of setting the size of each partitioned area of the storage area of the memory unit 310 by the main control unit 210 has been described.

However, it should be evident that the area partition information can be shared by sending the area partition information to the main control unit 210 after setting the size of the partitioned area in the supplementary control unit 220 not in the main control unit 210.

It should be evident that, as another method, the size of the data to be written by the control unit that is currently accessed to the shared area and the size of the writable storage area can be compared, and when the data is larger, the area partition information, which is first set to expand the size of the shared area, can be sent to the other control unit. If this method is used, the control unit accessed to the shared area can re-set the size of the partitioned area by itself, thereby minimizing the amount of information (e.g. the area re-partition request) transmitted between a plurality of control units.

Although detailed description of the above two methods is not provided, anyone of ordinary skill in the art should be able to easily understand the methods through the description above.

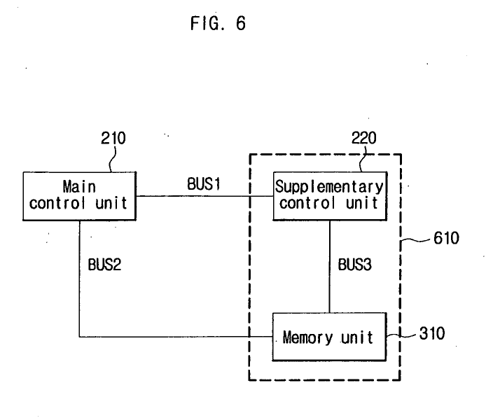

FIG. 6 is a block diagram showing a coupling structure between the main control unit, the supplementary control unit, and the memory unit in accordance with another preferred embodiment of the present invention.

As shown in FIG. 6, the supplementary control unit 220 and the memory unit 310 can be made to a single package 610. That is, by realizing the supplementary control unit 220 and the memory unit 310 in a single package, the area used in a printed circuit board can be reduced, thereby enabling the miniaturization of a portable terminal.

The drawings and detailed description are only an example of the present invention, serve only for describing the present invention, and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

### INDUSTRIAL APPLICABILITY

As described above, a portable terminal having a shared memory and a method for varying the size of partitioned areas of the shared memory can minimize the data transmission time and optimize the operation speed of each control unit by assigning a dedicated area to each of the plurality of control units coupled with the shared memory.

The present invention also enables the optimal memory partition by having the main control unit assign the storage area of a memory as a shared area and a dedicated area for each supplementary control unit.

Moreover, the present invention can ease the sharing of needed data by having a plurality of control units share a single memory.

Furthermore, the present invention enables a highly efficient data process by eliminating the unnecessary time loss when data stored in a specific memory is exchanged between each control unit.

What is claimed is:

1. A portable terminal having a partitioned memory unit comprising:
a memory unit, the memory unit having a plurality of dedicated memory areas, a shared memory area and at least one variable memory area;
a supplementary control unit, the supplementary control unit being coupled to said memory unit through a first bus, the supplementary control unit processing and storing raw data in accordance with a process order, the raw data being stored in said memory unit, the memory unit being accessed through said first bus; and
a main control unit, the main control unit being coupled to said memory unit through a second bus, the main control unit being coupled to said supplementary control unit through a third bus, the main control unit transmitting said process order to said supplementary control unit through said third bus,
whereas a first dedicated memory area is accessible by said supplementary control unit only, a second dedicated memory area is accessible by said main control unit only, and said shared memory area accessible by both said supplementary control unit and said main control unit, and said variable memory area is variably configured to be a part of one of said plurality of dedicated memory areas and shared memory area.

2. The portable terminal of claim 1, wherein said memory unit has a separate interface structure for communicating information with said supplementary control unit through said first bus and for communicating information with said main control unit through said second bus.

3. The portable terminal of claim 1, wherein a first control unit generates said partition control signal for said variable configuration of said variable memory areas and transmits said partition control signal to a second control unit through said third bus, wherein said first control unit is either said main control unit or said supplementary control unit, and said second control unit is the other of either said main control unit or said supplementary control unit.

4. The portable terminal of claim 3, wherein, if size of data to be written by said first control unit is larger than the size of writable capacity of the memory allocated to said first control unit, said first control unit generates re-partition control signal so that the size of said allocated memory area is expanded by including partial or whole said variable memory area.

5. The portable terminal of claim 1, wherein said second bus has priority over said first bus.

6. The portable terminal of claim 1, wherein said process order comprises instruction information on the process type of said raw data and a storage location of said raw data.

7. The portable terminal of claim 6, wherein said process order further comprises location information for storing raw data processed to correspond to said instruction information.

8. A method for variably configuring size of partitioned areas of a memory unit in a portable terminal, the portable terminal comprising a memory unit, a main control unit being coupled to said memory unit through a first bus, and a supplementary control unit being coupled to said memory unit through a second bus and said supplementary control unit being coupled to said main control unit through a third bus, the method comprising the steps of:
generating partition control signal for partitioning a storage area of said memory unit into a plurality of partitioned areas, wherein said partitioned area comprises at least a first dedicated memory area accessible by said main control unit only, a second dedicated memory area accessible by said supplementary control unit only, and a shared memory area and a variable memory area accessible by both said main control unit and said supplementary control unit, and wherein said variable memory area is variably configured to be a part of at least one of said first dedicated memory area, said second dedicated memory area, and said shared memory area corresponding to said partition control signal;
determining whether size of data to be written is larger than the size of the writable capacity of the memory allocated to said main control unit; and
generating re-partition control signal if the size of the data to be written is larger than the size of the writable capacity of the memory allocated to said main control unit,
reallocating at least a portion of said variable memory area for the main control unit, which has not been allocated for the main control unit wherein the size of said shared memory area is expanded by including partial or whole said variable memory area, included in at least one of said first dedicated memory area and said second dedicated memory area, in said shared memory area in accordance with said area re-partition information.

9. The method of claim 8, further comprising the steps of:
said supplementary control unit accessing said shared memory area in order to write data;
said supplementary control unit determining whether the size of the data to be written is smaller than the size of the writable area of said shared memory area; and
if bigger, said supplementary control unit transmitting an area re-partition request to said main control unit,
whereas said main control unit generates said area re-partition information in accordance with said area re-partition request, and the size of said shared memory area is expanded in accordance with said area re-partition information.

10. The method of claim 8, wherein either said main control unit or said supplementary control unit, accessed to said shared memory area, transmits access status information to the other of either of said main control unit or said supplementary control unit through said bus #3.

11. A recorded medium tangibly embodying a program of instructions executable by a portable terminal to execute a method for varying the size of partitioned areas of a shared memory, the program readable by said portable terminal, wherein said portable terminal comprises a memory unit, a main control unit, and a supplementary control unit, said main control unit coupling with said memory unit through a first bus, said supplementary control unit coupling with said memory unit through a second bus, said main control unit and said supplementary control unit coupling with each other through a third bus, the recorded medium executing the acts of:
said main control unit setting area partition information, for partitioning a storage area of said memory unit into a plurality of partitioned areas, and transmitting to said supplementary control unit, wherein said partitioned area comprises at least a first dedicated memory area accessible by said main control unit only, a second dedicated memory area accessible by said supplementary control unit only, and a shared memory area and a variable memory area accessible by said main control unit and said supplementary control unit, and said variable unit is included in at least one of said first dedicated memory area, said second dedicated memory area, and said shared memory area by said area partition information;
said main control unit accessing said shared memory area in order to write data;
said main control unit determining whether the size of the data to be written is smaller than the size of the writable area of said shared memory area; and
if bigger, said main control generating area re-partition information and transmitting to said supplementary control unit, wherein the size of said shared memory area is expanded by including partial or whole said variable memory area, included in at least one of said first dedicated memory area and said second dedicated memory area, in said shared memory area in accordance with said area re-partition information.

12. The recorded medium of claim 11, further comprising the acts of:
said supplementary control unit determining whether said shared memory area is accessible in order to write data;
if accessible, said supplementary control unit determining whether the size of the data to be written is smaller than the size of the writable area of said shared memory area; and
if bigger, said supplementary control unit generating area re-partition information and transmitting to said main control unit.

13. The recorded medium of claim 11, further comprising the acts of:
said supplementary control unit determining whether said shared memory area is accessible in order to write data;
if accessible, said supplementary control unit determining whether the size of the data to be written is smaller than the size of the writable area of said shared memory area;
if bigger, said supplementary control unit transmitting an area re-partition request to said main control unit, and
said main control unit generating said area re-partition information and transmitting to said supplementary control unit.

14. The recorded medium of claim 11, wherein:
said memory unit transmits an inaccessible message to a second control unit if said second control unit attempts to access said shared memory area to write data while a first control unit is accessed to said shared memory area and is writing data, and
said first control unit is either said main control unit or said supplementary control unit, and said second control unit is the other of either said main control unit or said supplementary control unit.

15. The recorded medium of claim 11, wherein said main control unit transmits access status information to said supplementary control unit in case said main control unit accesses said shared memory area to write data.

16. The portable terminal of claim 1, wherein said variable memory area is variably configured to be a part of one of said plurality of dedicated memory areas and shared memory area corresponding to partition control signal from one of said main control unit and said supplementary control unit.

17. The portable terminal of claim 1, wherein said at least one variable memory area comprises a plurality of variable memory area and wherein each of the plurality of variable memory area is variably configured to be a part of one of said plurality of dedicated memory areas and shared memory area.
